(19) United States
(12) Patent Application Publication
(10) Pub. No.: US 2003/0021595 A1
(43) Pub. Date: Jan. 30, 2003

(54) Apparatus and method for vaporizing a liquid chemical

(76) Inventors: Mindi Xu, Naperville, IL (US); Hwa-Chi Wang, Naperville, IL (US)

Correspondence Address: E. Joseph Gess, BURNS, DOANE, SWECKER & MATHIS, L.L.P., P.O. Box 1404, Alexandria, VA, 22313-1404, US

(21) Appl. No.: 10/192,670

(22) Filed: Jul. 11, 2002

Related U.S. Application Data
(60) Provisional application No. 60/305,072, filed on Jul. 16, 2001.

(51) Int. Cl. C10K 1/00; F02M 23/00; F02M 23/08; F24H 1/18; F22B 1/28

(52) U.S. Cl. 392/400; 392/401; 261/133; 261/134

(57) ABSTRACT

Provided are apparatuses and methods for vaporizing a liquid chemical to form a vapor phase product. One exemplary apparatus includes: a vaporization chamber, which includes a first annular wall having a plurality of openings and enclosing a vaporization space and a second annular wall disposed within the first annular wall, the first and second annular walls forming an annular space therebetween; a first conduit connected to the vaporization chamber for introducing thereto a liquid chemical to be vaporized; a second conduit connected to the vaporization chamber for introducing a carrier gas to the annular space, wherein the carrier gas flows from the annular space through the first annular wall to the vaporization space; and a third conduit connected to the vaporization chamber for supplying the vapor phase product to a point of use. Other exemplary features of the vaporization apparatuses include a gas dispersion jet for forming liquid chemical droplets in the vaporization chamber, a separation chamber for removing particulates in the vaporized chemical, and a solvent cleaning system for cleaning the vaporization apparatus. The apparatuses and methods allow for vaporization without decomposition, liquid re-condensation, chemical channel blockage or impurity contamination, while being easy to control for a desired flow rate, temperature and pressure to provide a precursor vapor excellent in quality. The apparatuses and methods have particular applicability to the semiconductor manufacturing industry for supplying chemicals to semiconductor processing tools, for example, to chemical vapor deposition (CVD) tools.

### CROSS-REFERENCE TO RELATED APPLICATIONS

This application claims the benefit under 35 U.S.C. §119(e) of provisional Application No. 60/305,072, filed Jul. 16, 2001, the entire contents of which are herein incorporated by reference.

### BACKGROUND OF THE INVENTION

1. Field of the Invention

This invention relates to novel apparatuses for vaporizing a liquid chemical to form a vapor phase product. The invention also relates to novel methods of vaporizing a liquid chemical to form a vapor phase product. The invention has particular applicability to the semiconductor manufacturing industry for supplying chemicals to semiconductor processing tools, for example, to chemical vapor deposition (CVD) tools.

2. Description of the Related Art

In a number of integrated circuit (IC) manufacturing processes, various reactive chemicals or chemical precursors are employed for the formation of films on a semiconductor wafer surface. Such films include, for example, insulation, barrier and conductive layers. The chemical precursors are typically deposited on the substrate by a chemical vapor deposition (CVD) method. Chemical vapor deposition methods include, for example, low pressure, atmospheric pressure and plasma enhanced CVD methods. For conducting chemical vapor deposition, the precursors that typically are in a liquid state are supplied by a chemical supplying system to a vaporizer where the precursors are vaporized. The precursor vapors are then supplied to a processing chamber where the wafer to be treated is disposed. The chamber is temperature and pressure controlled, and in the case of plasma enhanced chemical vapor deposition (PECVD), an electrode, inductive coil or microwave generation system is also controlled for plasma generation. The precursors are typically reactive with one or more additional gas to form a film on the wafer. For purposes of achieving desired film characteristics such as thickness, thickness uniformity, stoichiometry, refractive index, etc., it is desirable to carefully control the purity and delivery rate of the chemical while maintaining a constant temperature, stoichiometry, and pressure in the chemical delivery system.

Early attempts to supply the precursor chemicals were focused on vaporizing liquid chemicals. One example of a technique for providing a vaporized chemical is a bubbler in which the liquid precursor chemical is contained at either a controlled or ambient temperature. The liquid precursor is vaporized by bubbling a carrier gas through the liquid and delivering the resulting vapor to a deposition chamber. Bubblers can indeed be successful in supplying chemical precursors to a deposition chamber. They are, however, limited to use with precursors having relatively high vapor pressures at standard ambient conditions. The delivery flow rate and stoichiometry of precursor chemicals are largely dependent on the pathway of the carrier gas, temperature and pressure of the bubbler, and volume/height of liquid inside the bubbler. It is very difficult to maintain a constant precursor flow rate due to changes of the liquid chemical volume/height inside the bubbler. Although this problem can be solved by utilizing a primary container to supply liquid to the bubbler for maintaining a constant liquid chemical volume/height, entrained droplets and condensate can still vary the delivery rate of precursor chemicals.

Other attempts to vaporize and deliver liquid precursor chemicals have included atomization of the liquid chemical to form droplets. The droplets are either jetted into a heated chamber or out of a heated surface for vaporization. A carrier gas can be used to carry the vaporized chemical to a deposition chamber. A particular problem with this method is that the chemical precursor decomposes upon contact with the heated surfaces. Another problem is that residue particles are formed after vaporization of precursor chemicals. These particles may either block the delivery channel or be carried into the processing chamber as impurities. In this case, deposition quality is deteriorated due to lack of sufficient chemical vapor delivered to the chamber, and increased particulate impurities in the delivered chemicals and on the wafer surface.

Direct introduction of a liquid precursor onto a meshed or solid flat metal surface has also been attempted. The metal surface is typically heated to provide heat of vaporization to the liquid chemical precursor. A drawback associated with this vaporization technique is that the precursor chemical is easily overheated and decomposes on the metal surfaces. The chemical decomposition not only consumes the very precious precursor chemicals but also introduces contaminants into the precursor vapor which are delivered to the processing chamber. As the liquid chemical is vaporized, a solid residue is left behind on the metal surfaces. The residue may remain on the metal surfaces and significantly reduce the heat transfer from the metal surfaces to the liquid chemical. The vaporization will therefore not be performed as stably as it should be. This residue can also block the liquid channels from which the liquid precursor is delivered to the vaporization surfaces. As the residue builds up on the surfaces, it tends to shed off the surfaces and form particulate contamination in the chemical vapor.

Another known method to vaporize a liquid precursor chemical is to atomize a heated liquid chemical for vaporization. Once the liquid droplets jet into a small chamber, they become vaporized as a result of the latent heat of the liquid. However, the liquid easily decomposes under the high temperature used. The decomposed products become impurity contaminants and degrade the quality of the films formed on the wafers, as with the aforementioned heated surface technique. Another problem associated with this technique is the blocking of the atomizer by the decomposition products, making the vaporization process extremely unstable.

Accordingly, there remains a need in the art for improved apparatuses and methods for vaporizing liquid precursor chemicals for delivery to semiconductor processing tools, for example, chemical vapor deposition systems, which overcome the drawbacks associated with the related art.

### SUMMARY OF THE INVENTION

To overcome or conspicuously ameliorate the problems associated with the related art, it is an object of the present invention to provide novel apparatuses and methods for vaporizing a liquid chemical. The apparatuses and methods beneficially allow for the vaporization of a variety of liquid chemical precursors having various chemical and physical properties. The vaporization can advantageously be accomplished without decomposition, liquid re-condensation, chemical channel blockage, deposition on the vaporizer internal surfaces, or impurity contamination of the chemical vapor or wafer surface, while being easy to control for a desired flow rate, temperature, and pressure to provide a product vapor excellent in quality. Further, the system can conveniently be cleaned and purged as needed, and can be assembled and disassembled in a simple manner. The drawbacks associated with the apparatuses and methods in the prior art, such as liquid deposition on surfaces, stoichiometry shift of chemical vapor and carrier gas due to liquid deposition and chemical decomposition on surfaces can thereby be minimized or eliminated.

In accordance with a first aspect of the invention, an apparatus for vaporizing a liquid chemical to form a vapor phase product is provided. The apparatus includes: a vaporization chamber, having a first annular wall which has a plurality of openings and enclosing a vaporization space and a second annular wall disposed within the first annular wall, the first and second annular walls forming an annular space therebetween; a first conduit connected to the vaporization chamber for introducing thereto a liquid chemical to be vaporized; a second conduit connected to the vaporization chamber for introducing a carrier gas to the annular space, wherein the carrier gas flows from the annular space through the first annular wall to the vaporization space; and a third conduit connected to the vaporization chamber for supplying the vapor phase product to a point of use.

In accordance with a further aspect of the invention, an apparatus for vaporizing a liquid chemical to form a vapor phase product is provided. The apparatus includes: a vaporization chamber; a first conduit connected to the vaporization chamber for introducing thereto a liquid chemical to be vaporized; a second conduit connected to the vaporization chamber for introducing thereto a carrier gas; a separation chamber at an upper end of the vaporization chamber for removing particles from the vaporized chemical; and a third conduit connected to the separation chamber for supplying the vapor phase product to a point of use.

In accordance with a further aspect of the invention, an apparatus for vaporizing a liquid chemical to form a vapor phase product is provided. The apparatus includes a vaporization chamber that includes a first conduit connected to the vaporization chamber for introducing thereto a liquid chemical to be vaporized; a second conduit connected to the vaporization chamber for introducing thereto a carrier gas; a third conduit connected to the vaporization chamber for introducing thereto a dispersion gas to be contacted with the liquid chemical; a gas dispersion jet in fluid communication with a space for receiving the liquid chemical supplied from the first conduit and the dispersion gas supplied from the third conduit and jet for forming liquid droplets of the liquid chemical; and a fourth conduit connected to the vaporization chamber for supplying the vapor phase product to a point of use.

In accordance with a further aspect of the invention, an apparatus for vaporizing a liquid chemical to form a vapor phase product is provided. The apparatus includes: a vaporization chamber; a first conduit connected to the vaporization chamber for introducing thereto a liquid chemical to be vaporized from a liquid chemical source; a second conduit connected to the vaporization chamber for introducing thereto a carrier gas for supplying heat of vaporization to the liquid chemical; a third conduit connected to the vaporization chamber for supplying the vapor phase product to a point of use; and a fourth conduit in fluid communication with one or more of the fist conduit, the second conduit, the third conduit and the vaporization chamber for introducing thereto a cleaning solvent.

In accordance with further aspects of the invention, novel methods for vaporizing a liquid chemical are provided.

### BRIEF DESCRIPTION OF THE DRAWINGS

Other objects and aspects of the present invention will become apparent to one of ordinary skill in the art on a review of the specification, drawings and claims appended hereto, in which like reference numerals denote like features, and in which:

FIG. 1 is a cross-sectional view of an exemplary vaporizer in accordance with the present invention;

FIGS. 2A-C depict the gas dispersion jet shown in FIG. 1 in various views;

FIGS. 3A-C illustrate a further exemplary gas dispersion jet which can be used in the vaporizers in accordance with the invention;

FIG. 4 illustrates an exemplary vaporization system in accordance with the invention;

FIG. 5 is a cross-sectional view of a further exemplary vaporizer in accordance with the present invention;

FIG. 6 illustrates a further exemplary vaporization system in accordance with the present invention; and

FIG. 7 illustrates a further exemplary vaporizer in accordance with the present invention.

### DETAILED DESCRIPTION OF PREFERRED EMBODIMENTS OF THE INVENTION

A variety of chemical precursors have been used in various chemical vapor deposition processes, for example, in manufacturing electronic components such as integrated circuits, other semiconductor products, and printed circuit boards, and in optical fiber manufacturing.

The chemical precursors that are used to grow thin films or layers on semiconductor substrates are typically in either liquid or solid state at standard temperature and pressure. Precursors in solid state are typically dissolved in a solvent to form the liquid chemical. Others may be in a gaseous state at standard conditions but change to liquid state under higher pressure and/or lower temperature. These gaseous form chemicals are typically stored as a liquid in a pressurized and/or temperature controlled vessel.

As used herein, the term “liquid” denotes the status of the material to be vaporized as introduced into the vaporization chamber of the apparatuses in accordance with the invention. For example, chemicals which are gases at standard temperature (25° C.) and pressure (1 atm) and which are stored and introduced into the vaporization chamber in liquid form are considered to be liquid chemicals for purposes of the invention, as are solids in solution.

One or more liquid precursors can be introduced into the vaporization apparatus. Selection of a particular chemical precursor will depend, for example, on the purpose of the layer being formed and the characteristics desired. Typical applications in the case of semiconductor manufacture include interlayer dielectric layers, metal interconnect layers, barrier metal layers, gate electrode layers, and capacitor film layers. Chemical precursors that may be vaporized and delivered using systems and methods of the present invention include, for example, trimethylsilane, tetramethylsilane, dimethyl-dimethoxy-silane, copper(II)bis (hexafluoroacetylacetonate), copper(II)hexafluoro-acetylacetonate tetramethylvinylsilane, triisobutylaluminum, trimethylaminalane, triethylaminalane, dimethylethylaminalane, bis(trimethylamin)alane, dimethylaluminumhydride, titanium tetrachloride, tetrakisdimethylaminotitanium (TDMAT), tetra- or penta-kisdiethylamino titanium (Ta(Net)₄/Ta(Net)₅), tantalum pentachloride (TaCl₅), tungsten hexocarbonyl (W(CO)₆), bisdipivaloylmethanato barium (Ba(DPM)₂), bisdipivaloylmethanato strontium (Sr(DPM)₂), bisisopropoxybisdipivaloylmethanato titanium (Ti(I—OC₃H₇)₂DPM₂), trimethylaluminum (TMA), tetrakisdimethylamino zirconium (Zr(NME)₄), tetrakisdiethylamino zirconium (Zr(Net)₄), zirconium t-Butoxide (Zr(t-OBu)₄, tetrakisdiethylamino hafnium (Hf(Net)₄), tetrakisdimethylamino hafnium (Hf(NME)₄), hafnium t-Butoxide (Hf(t-Obu)₄), trihexafluoroacetylacetate platinum (Pt(Hfa)₃), bis(ethylcyclopentadienyl) ruthenium (EtCp₂Ru), acetylacetate iridium (Ir(Acac)), other dipivaloylmethane and alkoxide compounds, bisdipivaloylmethanato lead (Pb(DPM)₂), bisdipivaloylmethanato zirconium (Zr(DPM)₄), trimethyl bismuth (BiMe₃), or, tetraethylorthosilicate (TEOS), tantalum pentaethoxide (Ta(OEt)₅), tetramethylcyclotetrasiloxane (TMCTS),

bis(tertiary-butylamino)silane (BTBAS), trimethylphosphate (TMPO), trimethylborate (TMB), and trimethylphosphite (TMPI).

Preferred solvents in the case of a solid precursor include, for example, water, isopropanol, tetrahydrofuran, isopropanol/tetrahydrofuran mixtures, tetraglyme, xylene, toluene, butyl acetate, benzonitrile, ethanol, hexane, octane, and combinations thereof. A particular solvent for a particular solid precursor is typically selected based on the physical and chemical properties of the solid precursor and solvent. Solvents, for example, those listed above, can be used for the aforementioned types of precursors whether in solid, liquid or gas form at standard conditions, depending on the particular materials.

One or more gas or gas mixture is supplied to the vaporizer as a dispersion gas which interacts with the liquid chemical to form droplets of the chemical and/or as a carrier gas which is typically used to mix with the chemical vapor to achieve a specific vapor concentration of the chemical, for attaining a particular chemical stoichiometry, and/or for producing new chemical molecules. Gases useful for these purposes include, for example, inert gases, such as argon (Ar), helium (He), hydrogen (H₂), and nitrogen (N₂), and active gases, such as oxygen (O₂), ozone (O₃), water vapor (H₂O), ammonia (NH₃), and nitric oxide (NO), and combinations thereof. The dispersion gas may be the same or different than the carrier gas.

The vaporized chemical product from the vaporizer is typically delivered to one or more points of use. The point of use can be a CVD system, for example, a low pressure CVD (LPCVD), atmospheric pressure CVD (APCVD) or plasma enhanced CVD (PECVD) system, used in the formation of electronic components such as semiconductor devices or printed circuit boards, or in the manufacture of optical fibers.

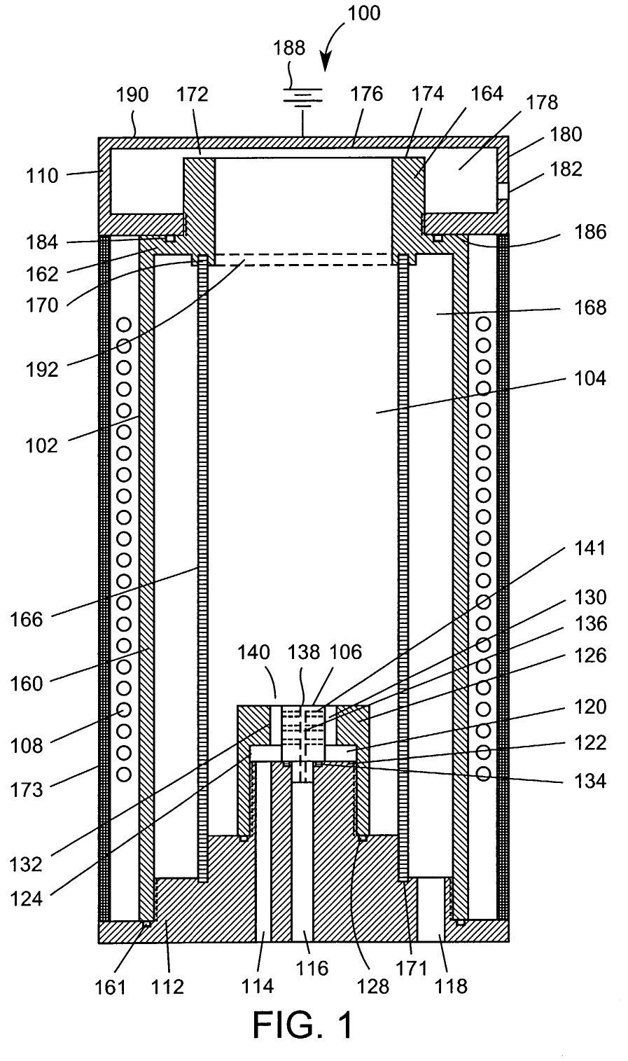

The invention will now be discussed with reference to FIG. 1, which is a cross-sectional view of an exemplary vaporizer 100 in accordance with a first aspect of the present invention. The vaporizer includes a vaporization chamber 102 enclosing a vaporization space 104, a gas dispersion jet 106 for generating droplets of the liquid chemical, a heater 108, and a particle trap 110 for separating and removing particles from the vaporized chemical product.

A base body 112 has a circular top projection and preferably a plurality of gradient levels adapted to receive different parts of the vaporization chamber. A plurality of channels 114, 116, 118 which are typically cylindrical are provided for introduction of the liquid chemical and dispersion/carrier gas into the vaporizer. The channels include a first channel 114 for receiving a liquid chemical to be vaporized from a liquid chemical introduction conduit, a second channel 116 for receiving a dispersion gas for generating liquid particles from a dispersion gas introduction conduit, and a third channel 118 for receiving a carrier gas from a carrier gas conduit. The first channel 114 is typically from about 1 mm to 1 cm in diameter with an NPT thread at its outside end for connection to a liquid chemical introduction conduit. The other end of the first channel is in fluid communication with a liquid chamber 120 which receives the liquid chemical from the first channel 114. The liquid chamber is typically an annular chamber defined by the top surface 122 of the base body, the outer periphery of the gas dispersion jet 106, and a portion 124 of the inner surface of a cup body 126. The second channel 116 is preferably disposed at the center of the base body 112 and typically has a diameter of from about 1 mm to 1 cm. The second channel 116 preferably has threads at both ends for ease of connection with the dispersion gas introduction conduit and for connection to the gas dispersion jet 106. The third channel 118 typically has a diameter of from about 1 mm to 1 cm, preferably about 5 mm, with threads at its outside end for connection with the carrier gas introduction conduit.

The cup body 126 is preferably removably threaded onto the base body 112 and sealed with an o-ring 128 to the base body. The liquid chamber 120 is designed to provide a uniform distribution of the liquid chemical for spraying purposes and with a minimum liquid holding volume to avoid or minimize decomposition of the liquid chemical. An annular spraying channel 130 is defined by a portion 132 of the inner surface of the cup body 126 above the liquid chamber 120 and the outer periphery of the gas dispersion jet 106. The liquid chamber 120 can optionally be eliminated by having the first channel 114 communicate directly with the annular spraying channel 130.

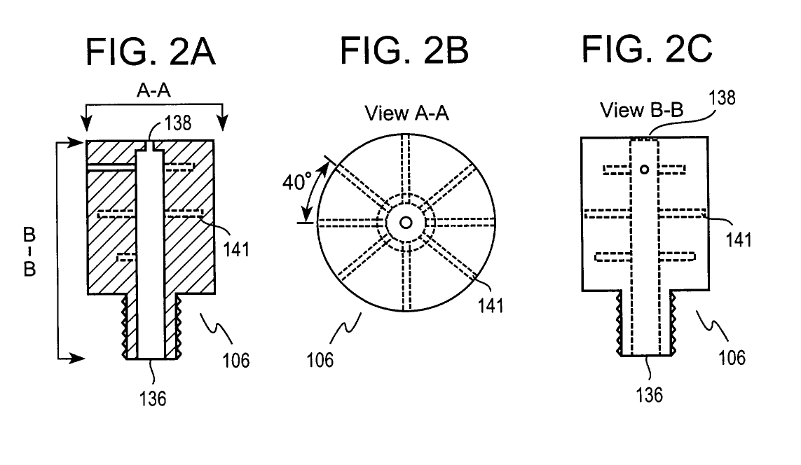

The gas dispersion jet 106 is typically removably threaded into the second channel 116 and sealed with an o-ring 134 with the advantage of easy disassembly for maintenance and cleaning purposes. The gas dispersion jet can optionally be formed integrally with the base body 112. Typically, the gas dispersion jet is formed from stainless steel or other material compatible with the liquid chemical. FIGS. 2A-C are various views of the gas dispersion jet 106. The gas dispersion jet is preferably cylindrical in shape and includes a central channel 136 along its central axis that allows the dispersion gas to flow from the second channel 116 through the gas dispersion jet. The central channel 136 extends to the top surface 138 of the gas dispersion jet, preferably with a reduced opening diameter at the top. This allows the dispersion gas to be jetted not only into the annular liquid channel 130 to form liquid chemical droplets at location 140 but also out the top 138 of the jet, thereby preventing collapse of the liquid droplets generated in the annular liquid channel, and helping to ensure vertical motion of the droplets and ensuring efficient vaporization.

A plurality of openings 141 from the central channel 136 are provided in the radial direction of the gas jet 106 to allow for flow of the dispersion gas from the central channel 136 to the annular spraying channel 130. The dispersion gas thereby is allowed to mix with the liquid chemical and form the small droplets which are introduced into the vaporization space 104 above the annular spraying channel and gas dispersion jet. The openings 141 can be in the form of pores of a porous material such as a sintered metal or ceramic, or can be formed, for example, by machining. The openings 141 preferably have a diameter of from about 5 to 100 μm, more preferably from about 10 to 20 μm, for example about 15 μm, for small droplet production. In the illustrated embodiment, nine total openings 141 are provided in three layers having three openings each, with the layers being offset from each other by 40°. This allows for uniform introduction of the dispersion gas into the liquid chemical over a greater area of the annular spraying channel 130.

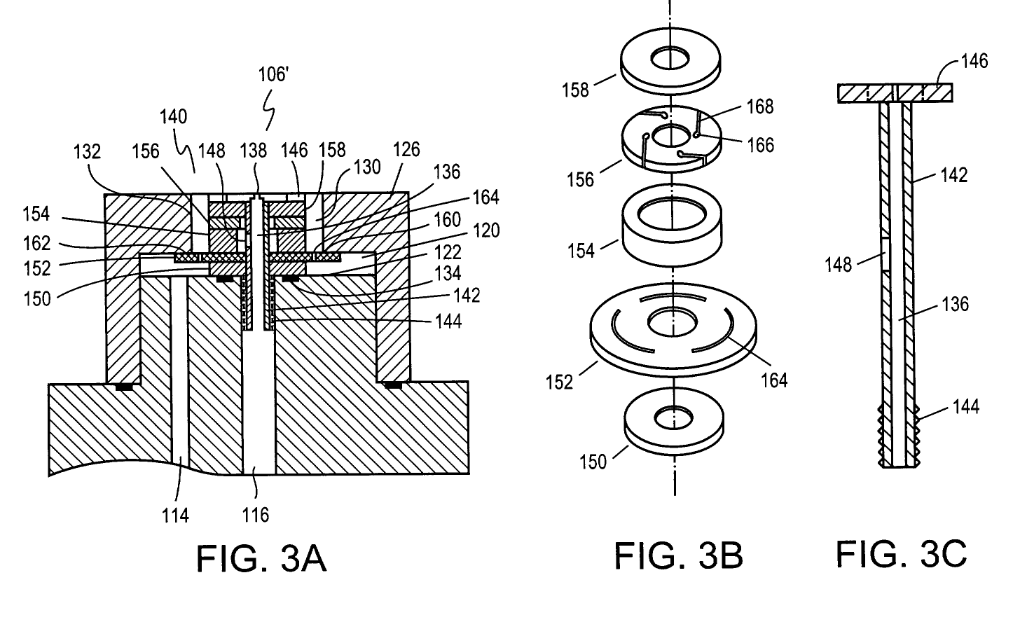

FIGS. 3A-C illustrate a further exemplary gas dispersion jet 106′ which can be used in the vaporizers in accordance with the invention. This gas dispersion jet includes a fastening rod 142 with threads 144 at a first end for fastening the rod to the second channel 116 in the base body, and a fastening nut 146 at the opposite end for ease in fastening the rod. The fastening rod has a central channel 136 along its central axis for passage of the dispersion gas, the central channel preferably being of reduced diameter at the end of the fastening rod facing the vaporization space. An opening 148 is provided in one side of the fastening rod 136 through which the dispersion gas is allowed to pass from the central channel 136. A plurality of disks are provided which, when assembled with the fastening rod, form the gas dispersion jet. The disks include, in stacking order, a first support disk 150, a liquid chemical inlet disk 152, a second support disk 154, a dispersion gas jet disk 156, and a top disk 158. The disks each have a central opening through which the fastening rod can pass, and are formed from a material which is compatible with the liquid chemical, for example, stainless steel. The annular spraying channel 130 is defined by the portion 132 of the inner surface of the cup body 126, the upper portion 160 of the liquid chemical inlet disk 152, and the outer peripheries of the second support disk 154, the dispersion gas jet disk 156, and the top disk 158.

The first support disk 150 is a solid disk having only the single opening through its center for receiving the fastening rod. The disk 150 is disposed on the upper surface 122 of the base body and forms a seal with the base body using an o-ring 134. The liquid chemical inlet disk 152 is disposed on the first support disk 150 and extends from the outer periphery of the fastening rod to beyond the annular spraying channel 130. A portion of the upper surface of the liquid chemical inlet disk 152 at the periphery is in contact and forms a seal with a portion 162 of the cup body. The liquid chemical inlet disk 152 separates the annular spraying channel 130 which is above the liquid inlet disk from the liquid chamber 120 below. In addition to the central opening, the liquid inlet disk has one or more apertures 164 aligned with the annular spraying channel 130 above, allowing the liquid chemical to flow from the liquid chamber 120 to the annular spraying channel 130. A plurality of the apertures 164 are typically provided in the disk 152, evenly distributed in the form of a circle, preferably as segments of a circle, to provide uniform flow of the liquid chemical into the annular spraying channel 130.

The second support disk 154 is disposed on the liquid chemical inlet disk 152, and is vertically aligned with the opening 148 in the fastening rod 142. The diameter of the central opening in the second support disk 154 is greater than the outer diameter of the fastening rod such that a gap exists therebetween, thus forming a passage through which the dispersion gas can flow in a vertical direction. The outer diameter of the second support disk 154 is small enough such that there is no overlap with the apertures 164 in the underlying liquid inlet disk 152. The dispersion gas jet disk 156 is disposed on the second support disk 154. The dispersion gas jet disk has a plurality of apertures 166 between the central opening and the outer periphery. Each of the apertures 166 has an associated slot 168 which extends from the aperture to the outside edge of the disk 156. When assembled, the apertures 166 lie over the central opening of the second support disk 154 and the grooves lie over the solid portion of the second support disk. The top disk 158 is typically identical to the first support disk, and the central opening thereof lies within the apertures 166 and slots 168 of the dispersion gas jet disk such that the solid portion thereof lies over and seals the apertures 166 and slots 168.

In operation, the liquid chemical is introduced into the gas dispersion jet 106′ through the first channel 114. The liquid chemical fills the liquid chamber 120, and passes through the liquid chemical apertures 164 in the liquid chemical inlet disk 152 into the annular spraying channel 130. The dispersion gas is introduced into the fastening rod central channel 136 through the second channel 116, and passes through the opening 148 in the side of the rod and out from the opening in the top 138 of the jet. The dispersion gas passes from the opening 148 into the gas jet apertures 166 of the dispersion gas jet disk 156 and through the slots 168 towards the disk's outer periphery and into the annular spraying channel 130 which contains the liquid chemical. The apertures 166 and slots 168 allow for torroidal flow of the dispersion gas through the slots into the liquid chemical in the annular spraying channel. Such flow aids in breaking the liquid chemical into small droplets.

In an alternative embodiment, one or more additional gas openings 148 in the fastening rod can be provided, together with an equivalent number of additional second support disks 154, dispersion gas jet disks 156, and top disks 158, stacked on the first top disk 150 to provide additional gas/liquid contact. The additional dispersion gas jet disks can be offset with respect to each other for uniformity of flow of the dispersion gas into the annular spraying channel 130. Moreover, while the exemplified jet is constructed of a plurality of discreet disks, the same structure can be formed as an integral unit.

As a result of the gas dispersion jets in accordance with the invention, the liquid chemical droplets produced by the gas dispersion jet can be uniformly distributed in the vaporization chamber due to the flow of the dispersion gas from the central area of the jet. Possible agglomeration of liquid droplets can thus be eliminated to accelerate vaporization of the liquid chemical droplets. In addition, channel blockage which occurs in conventional vaporization systems as a result of the presence of impurities or crystals in the liquid chemicals is not fatal due to the multi-channel jet structure. Consequently, termination of vaporization due to blockage can effectively be eliminated, as can excessive process downtime due to frequent cleaning of the channels of the gas dispersion jet.

It is envisioned that other means for creating liquid droplets may be employed in accordance with the invention. For example, a liquid can be introduced into a sintered metal or ceramic dispersing head, and droplets formed thereby without employing a dispersion gas.

Referring again to FIG. 1, the vaporizer system further includes an outer cylinder body 160 which is typically cylindrical in shape and forms an isolation wall of the vaporization chamber that functions to prevent ambient air from entering into the vaporization space 104 and also as a carrier or support body for the heater 108. The outer body 160 is preferably removably threaded into the base body 160 at one end. An o-ring 161 can be disposed between the base body and outer body to seal this connection to avoid leakage. At another end of the outer body 160, a shoulder portion 162 and a neck portion 164 are provided.

A porous cylinder 166 encloses the vaporization space 104, and forms an annular space 168 with the inner surface of the outer body 160. The annular space functions as a carrier gas chamber, and receives the carrier gas from the third channel 118. The porous cylinder 166 contains openings which allow the carrier gas to flow from the annular space 168 into the vaporization space in a uniform and even manner. Flow of the carrier gas through the walls of the porous cylinder 166 effectively prevents the liquid droplets and chemical vapor from coming into contact with the metallic wall surfaces. The porous cylinder is typically constructed of stainless steel or other material compatible with the liquid chemical and the vaporized chemical, and can take the form, for example, of a louvered tube of stainless steel, or a sintered metal or ceramic tube, having a plurality of holes which function as gas channels. The porous cylinder typically has a diameter of from about 5 mm to 10 cm, preferably from about 5 mm to 2.5 cm, and a height of from about 2.5 cm to about 100 cm, preferably from about 5 cm to 25 cm. The openings in the porous cylinder are typically from about 1 μm to 1000 μm in diameter. A circular slot 170 is provided inside of the shoulder portion 162 just below the neck portion 164 for receiving the upper end of the porous cylinder. The lower end of the porous cylinder 166 is inserted into a circular slot 171 in the base body 112. Optionally, the upper end and/or lower end of the porous cylinder 166 can be removably fixed in place, for example, by use of threading.

A heater 108 is provided to uniformly heat the dispersion/carrier gas in the carrier gas chamber 168 which is then mixed with and supplies heat of vaporization to the liquid chemical droplets, as well as to heat the mixture of droplets, chemical vapor, and dispersion/carrier gas inside the vaporization chamber. The heater can take the form, for example, of plural electric heating elements embedded inside the outer body 160 or an electric heating coil arranged around the outside surface of the outer body. The outer body is preferably formed of a high thermal conductivity material such as stainless steel which can quickly transfer heat from the heater to the dilution gas in the annular chamber. To prevent heat loss to ambient, a heating insulation layer 173 is preferably provided around the heater 108 and outer body 160. This heat insulation layer is particularly desirable when embedded heating elements are used.

The carrier gas functions to shield the porous cylinder 166 from contact with the liquid chemical droplets produced by the gas dispersion jet 106 and the vaporized chemical. Additionally, the carrier gas provides heat of vaporization to the liquid chemical droplets, and acts as a diluent for the vaporized chemical. The droplets are vaporized very rapidly because of the heat and the relatively large surface area of the droplets. The chemical vapor mixes fully with the heated carrier gas from chamber 168, and the mixture of chemical droplets, chemical vapor, and dispersion and carrier gas continue to flow downstream (up in FIG. 1) in the vaporization space 104, with the droplets continuing to vaporize as more heated carrier gas enters the vaporization space. Prior to reaching the upper end of the vaporization space, all of the liquid droplets are fully vaporized and the temperature of the chemical vapor/carrier gas mixture is at a point at which substantially no vapor condensation takes place on internal components of the vaporizer. As a result, formation of deposits from the chemical on internal surfaces of the vaporization chamber is prevented or minimized. The drawbacks associated with the methods in the prior art, such as liquid deposition on surfaces, stoichiometry shift of chemical vapor and carrier gas due to liquid deposition and chemical decomposition on surfaces can therefore be minimized or eliminated.

Another feature of the present invention is a particle trap or separation chamber 110 which effectively removes particles from the vaporized chemical. Particles are particularly detrimental in CVD processes as they deteriorate the quality of the deposited film and negatively impact the yield of the devices being formed. The separation chamber is used to remove residual particles left behind by the liquid droplets after the liquid chemical becomes vaporized. The separation chamber 110 is preferably in the form of a cylindrical box that forms a cap over the outer cylinder body 160, with an opening at its bottom to receive the neck portion 164 of the outer cylinder body. The neck portion 164 extends into the separation chamber such that a circular channel 172 is formed between the top surface 174 of the neck and the inner surface 176 of the upper end of the separation chamber. An annular space 178 is defined between the outer surface of the neck portion 164 and the sidewall 180 of the separation chamber. A vapor outlet opening 182 in the sidewall of the separation chamber allows for passage of the vaporized product from the vaporizer to a chemical vapor delivery conduit (not shown) for introduction of the vaporized chemical to one or more points of use. The separation chamber 110 can be fixed to the outer cylinder body 160 by welding or by threading. Threading is the preferred fastening technique for convenience of disassembly of the components for cleaning of the separation chamber. An o-ring 184 is disposed between the surface 186 of the separation chamber and the shoulder 162 of the cylinder body to provide a seal.

To enhance the removal of residue particles from the mixture of chemical vapor, dispersion gas, and carrier gas, i.e., the vapor-gas mixture, a low DC voltage from a DC power supply 188 can optionally be supplied to the top surface 190 of the separation chamber 110, thus converting the separation chamber into an electrode. Any residue particles carrying an electric charge will be electrostatically attracted to and collected by the top inner surface 176 of the separation chamber. To further improve residue particle removal, a vapor-gas jet disk 192 with a plurality of apertures can optionally be provided at the base of the outer body neck to improve the flow characteristics of the vapor-gas mixture. The vapor-gas mixture is jetted through the apertures of the jet disk 192 and the particles can more effectively be collected on the inner top surface of the separation chamber. The jet disk 192 can be constructed of the same materials that porous tube 166 is constructed.

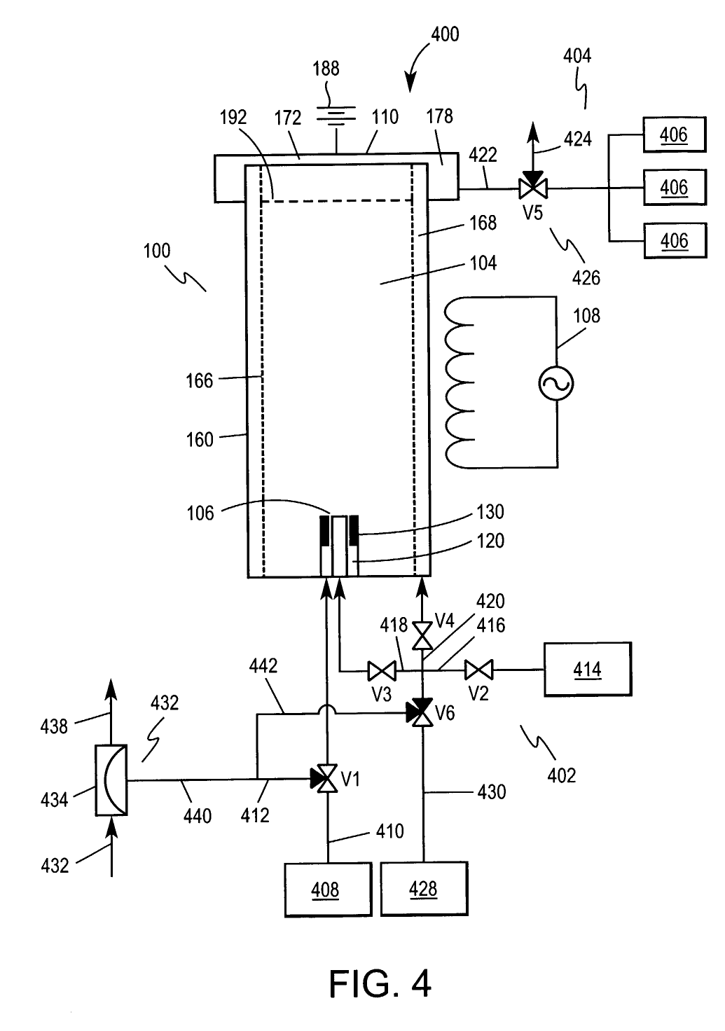

FIG. 4 illustrates an exemplary vaporization system 400 in accordance with the present invention which includes a vaporizer 100 as described above. The vaporization system includes, in addition to the vaporizer, a liquid chemical and dispersion/carrier gas delivery module 402 for introducing the liquid chemical and dispersion and carrier gases into the vaporizer, and a chemical vapor delivery module 404 for delivery of the chemical vapor/carrier gas mixture to one or more points of use 406. In the dispersion/carrier gas delivery module 402, the liquid chemical is supplied to the vaporizer from a liquid chemical source container 408 through a chemical delivery conduit 410 to the first channel of the vaporizer, with flow through the conduit being controlled by use of an isolation valve V1 which can be a three-way valve also connected to a vacuum conduit 412, allowing for evacuation of the conduit 410 and vaporizer 100. If desired, a plurality of liquid chemical sources can be connected to the vaporizer for delivering multiple chemicals thereto. The chemical delivery conduit 410 is typically ⅛ inch or larger in internal diameter and is typically constructed of stainless steel, for example, 316 stainless steel, or other material compatible with the liquid chemical. The isolation valve V1 can be constructed from the same material as the conduit 410.

The dispersion gas and carrier gas are supplied to the vaporizer from a dispersion/carrier gas source 414, but can be supplied from individual gas sources. The dispersion/carrier gas passes through a conduit 416, with flow being controlled by an isolation valve V2. The conduit 416 splits into a dispersion gas conduit 418 and a carrier gas conduit 420 with flow therethrough being controlled with valves V3 and V4, respectively. The dispersion/carrier gas thus flows into the second channel of the vaporizer from the dispersion gas conduit 418 and into the third channel of the vaporizer from the carrier gas conduit 420.

The vapor-gas mixture from the vaporization chamber is supplied to the one or more points of use from the annular space 178 of the vaporizer through a chemical vapor delivery conduit 422 which is connected to the vapor outlet opening of the separation chamber 110. The conduit 422 is typically heat insulated and is preferably heated with a heater, for example, a resistance-type heater or heating tape. A vent conduit 424 is preferably provided for diversion of the vaporizer effluent from the points of use to exhaust. Flow of the chamber effluent can be controlled with an isolation valve V5, which is typically a three-way valve connected to the chemical vapor delivery conduit 422, the vent conduit 424, and a point of use delivery conduit 426. During normal operation, isolation valve V5 is open to the point of use and closed to vent for chemical vapor delivery, and during system start-up or any cleaning procedure, valve V5 is open to vent and closed to the point of use.

The vaporization system is periodically cleaned to remove chemical residue from surfaces of the vaporizer. The residue can be dissolved and removed using a suitable solvent that can be conveniently introduced into the vaporizer and various conduits. The selection of the solvent will depend on the particular liquid chemical introduced and vapor species generated in the vaporizer. Typical solvents include, for example, those listed above with respect to the solvent used in the case of a solid precursor. The solvent flows from a solvent source 428 through a solvent supply conduit 430 that includes an isolation valve V6 to the gas conduits 416, 418, 420. When required, the solvent can flow through conduit 418 and/or 420 into the vaporizer for cleaning of the vaporizer components. The solvent can thus enter and clean the various openings and channels of the gas dispersion jet 106, as well as the other components which come into contact with the liquid chemical and chemical vapor. The solvent can backfill through the system into the chemical delivery conduit 410 or, optionally, the solvent supply can be connected directly into the chemical delivery conduit 410 by provision of an additional connecting conduit.

A vacuum system 432 is preferably provided that allows evacuation of the liquid chemical, solvent and dispersion/carrier gas conduits, as well as the vaporizer. The vacuum system can take the form of a venturi, as shown, with a venturi body 434 connected to a conduit 436 that is connected to a compressed air or high pressure nitrogen source and a vent conduit 438 connected to an exhaust system. Optionally, a vacuum pump can be used in place of the venturi, or connection can be made to a house vacuum system if present. The vacuum system is connected by vacuum conduits 440, 412 to the chemical delivery conduit 412 via three-way valve V1, and by vacuum conduits 440 and 442 to solvent supply conduit 430 via three-way valve V6.

An exemplary method of operating the vaporization system illustrated in FIG. 4 will be described. With valves V2, V3, V4 and V5 (vent) in the open position, and valves V1 (vacuum and liquid chemical), V5 (point of use), and V6 (vacuum and solvent) in the closed position, the dispersion/carrier gas flows from source 414 through conduit 416 at a preselected flow rate, typically greater than 100 sccm. A portion of the dispersion/carrier gas, typically less than 10% of the total flow, flows through conduit 418 to the gas dispersion jet 106. The remaining portion flows through conduit 420 to annular carrier/dilution gas chamber 168. The concentration of the product vapor can easily be adjusted by controlling the supply flow rates of the liquid chemical and dispersion/carrier gases.

Valve V1 (liquid chemical) is opened and the liquid chemical is transported at a predetermined flowrate, typically 4 ml/hr or greater, through liquid chemical conduit 410 to the liquid chemical chamber 120. The liquid chemical flowrate and dispersion/carrier gas flowrate will depend on the particular chemical precursor and configuration of the point of use, for example, a CVD process chamber. The liquid chemical from the liquid chemical chamber 120 fills the annular spraying channel 130, and the dispersion gas is sprayed out from the gas jet 106 in a radial direction into the liquid chemical in the annular spraying channel 130, with the chemical being broken into small droplets by the dispersion gas due to the delivery pressure of the liquid chemical and dispersion gas. The droplets typically have a diameter varying from about 10 to 100 μm. Chemicals having a low surface tension can form droplets of smaller diameter, while chemicals having a high surface tension can form droplets larger in diameter. As a result of the heat provided by the heater 108 and the carrier gas, the liquid droplets are vaporized and the temperature of resulting chemical vapor mixture is maintained at or above the condensation temperature at the operating pressure. The gas-vapor mixture flows from the vaporization space 104 into the separation chamber 110 through the vapor-gas jet disk apertures and the circular channel 172, into the annular space 178. The channel 172 restricts flow of the chemical vapor and carrier gas mixture, thus causing the vapor flow rate to reach a maximum in the channel 172. Inertia and electrostatic charge, in the case of a DC voltage, causes the residual particles to be collected on the top inner surface of the separation chamber 110, while the vapor-gas mixture flows into the annular space 178 and exits the vaporizer through the vapor outlet opening in the side of the separation chamber and flows through the conduits 422 and 424 to the point(s) of use 406.

At the onset of system cleaning, valves V2, V5 (vent and point of use), and V6 (solvent and vacuum) are set in the closed position, and valves V1 (vacuum), V3 and V4 are set in the open position. In this manner, any remaining liquid chemical, chemical vapor and dispersion/carrier gas in the system can be evacuated from the system through valve V1 by the vacuum system 432. System evacuation can be aided by the use of purge gas by allowing the dispersion/carrier gas to flow during evacuation by opening valve V2 while valve V1 (vacuum) remains open, or by performing a series of vacuum/purge cycles by opening and closing valves V1 (vacuum) and V2 in an alternating, high frequency manner. With valve V2 closed, valve V6 (solvent) and one or both of valves V3 and V4 open, and valve V1 (vacuum) either open or closed, the solvent is allowed to flow from the solvent source 428 to the vaporization chamber through one or both of conduits 418 and 420. After a brief period, valve V6 (vacuum) is open to evacuate any solvent, liquid chemical, vapor and gas from the vaporizer. Valve V1 (vacuum) can be opened and closed at the same time as valve V6 (vacuum). Valve V6 (solvent) and V6 (vacuum)can be opened and closed in an alternating, high frequency manner until completion of cleaning. Upon completion of cleaning, valves V1 (vacuum), V5 (point of use), V6 (solvent and vacuum) are set in the closed position, and valves V1 (liquid chemical), V2, V3, V4, V5 (vent) are set in the open position. Once it has been verified that the chemical vapor in vapor delivery conduit 422 is up to specification and the point of use is ready for delivery of the chemical vapor, valve V5 (vent) is closed and valve V5 (point of use) is opened, and the chemical vapor is delivered to the point(s) of use 406.

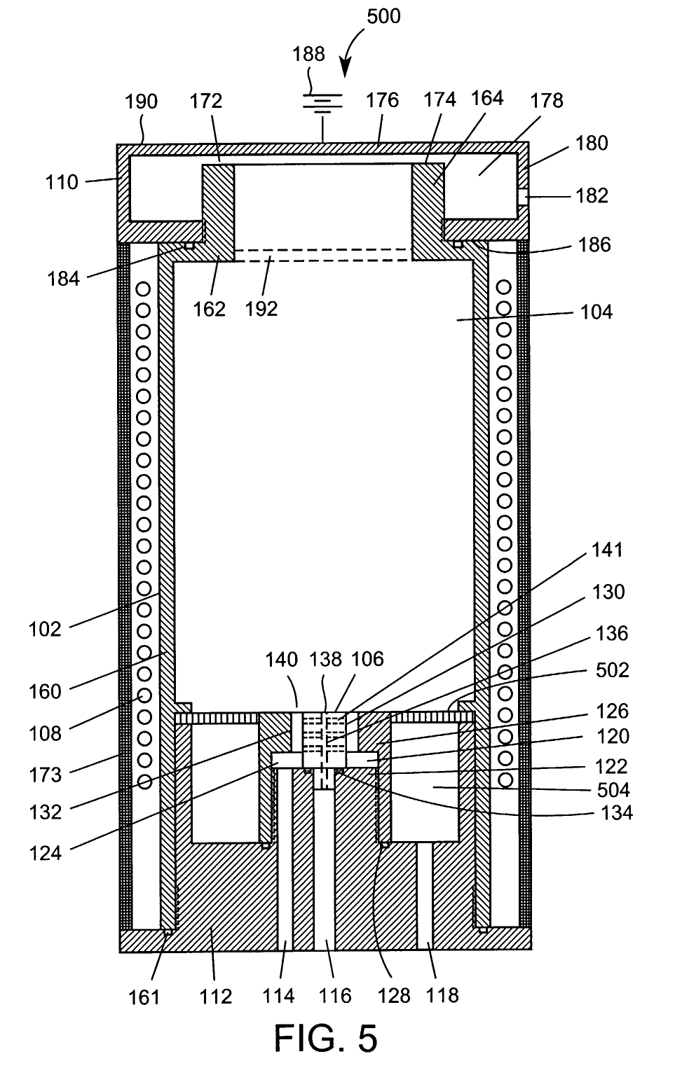

FIG. 5 is a cross-sectional view of an exemplary vaporizer 500 in accordance with a further aspect of the present invention. This embodiment differs from that illustrated in FIG. 1 in that the porous cylinder 144 and surrounding annular space 168 have been replaced with, respectively, a carrier gas distributor 502 located at the lower portion of the vaporization chamber and an annular carrier gas chamber 504 which receives the carrier gas from the third channel 118. The distributor 502 can be a metal or porous ceramic disk having a central opening that fits over the cup body 126 and a plurality of apertures that allow the carrier gas to pass into the vaporization space 104.

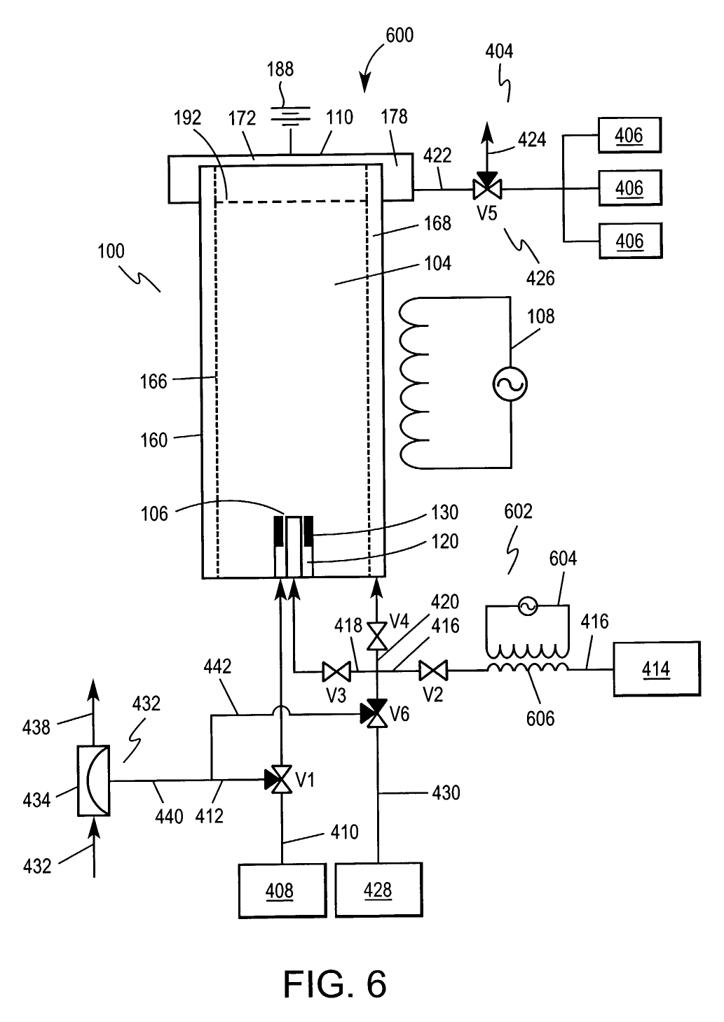

FIG. 6 illustrates an exemplary vaporization system 600 that includes the vaporizer shown in FIG. 5. This embodiment is identical to that shown in FIG. 4, except for the provision of a heater 602 for heating the dispersion carrier gas in conduit 416 prior to its entry into the vaporizer. The heater 602 is typically a heat exchanger which includes a heating portion 604, for example, a coil-type electric heater, heating tape, a heating lamp, heated gas or oil, or the like, and a heat exchanger portion 606 which can be, for example, a metal or quartz coil to allow the dispersion/carrier gas flowing through the coil to be exposed to the heating portion. The pre-heated dispersion/carrier gas provides the heat required for vaporizing the liquid droplets formed by the gas dispersion jet 106.

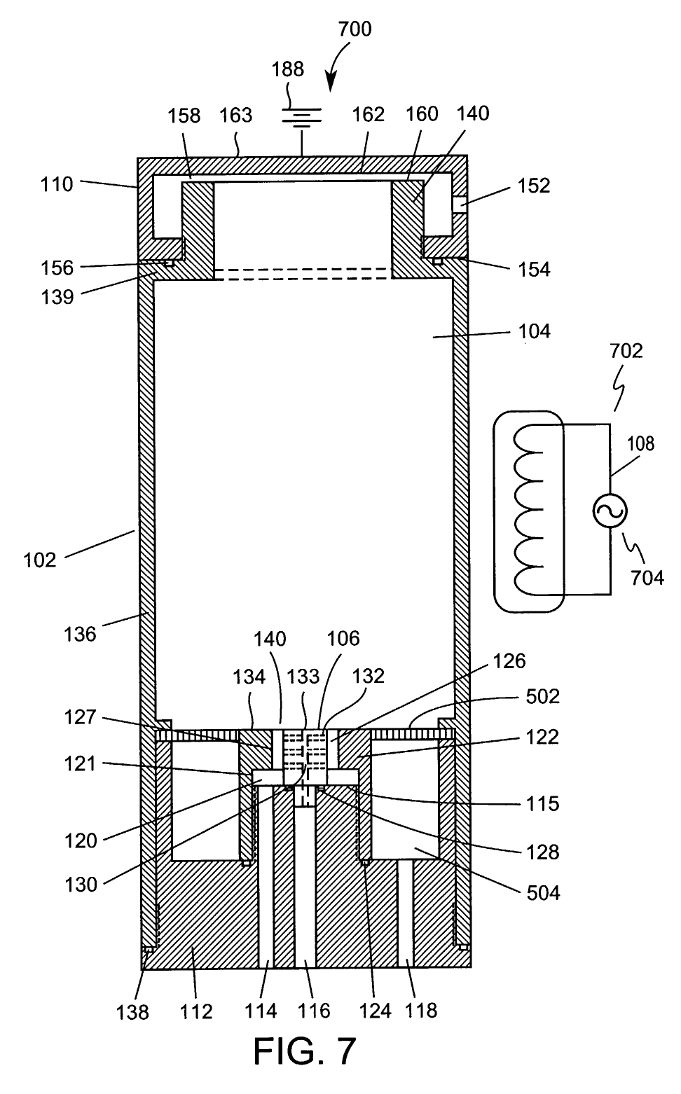

FIG. 7 illustrates an exemplary vaporizer 700 in accordance with a further aspect of the invention. This vaporizer is generally the same as that shown in FIG. 5, except for the provision of a microwave heater 702 with a microwave generator 704 for providing heat of vaporization to the vaporization chamber. The materials of the vaporization chamber are constructed of a microwave transmissive material, such as glass or quartz, to allow the microwaves to penetrate into the vaporization space 104 so they can be absorbed by the liquid chemical droplets therein. Since the microwave energy will only be absorbed by the liquid droplets, the droplets vaporize rapidly to produce the chemical vapor. The vaporizer can be used, for example, in the vaporization system shown in FIG. 6.

While the invention has been described in detail with reference to specific embodiments thereof, it will be apparent to one skilled in the art that various changes and modifications can be made, and equivalents employed, without departing from the scope of the appended claims.

What is claimed is:

1. An apparatus for vaporizing a liquid chemical to form a vapor phase product, comprising:
a vaporization chamber, comprising a first annular wall comprising a plurality of openings and enclosing a vaporization space and a second annular wall disposed around the first annular wall, the first and second annular walls forming an annular space therebetween;
a first conduit connected to the vaporization chamber for introducing thereto a liquid chemical to be vaporized;
a second conduit connected to the vaporization chamber for introducing a carrier gas to the annular space, wherein the carrier gas flows from the annular space through the first annular wall to the vaporization space; and
a third conduit connected to the vaporization chamber for supplying the vapor phase product to a point of use.

2. The apparatus according to claim 1, further comprising a heater around the second annular wall for heating the carrier gas in the annular space.

3. The apparatus according to claim 2, wherein the heater comprises plural electrical heating elements or an electric heating coil.

4. The apparatus according to claim 1, wherein the vaporization chamber further comprises a separation chamber at an upper end thereof for removing particles from the vaporized chemical.

5. The apparatus according to claim 4, wherein the separation chamber comprises a cap over the upper end of the vaporization chamber, and wherein the third conduit is connected to the cap.

6. The apparatus according to claim 5, wherein the cap is spaced apart from the upper end of the vaporization chamber, forming a gap therebetween, and the cap forms an annular space with an outer portion of the vaporization chamber, whereby the vaporized chemical passes through the channel into the annular space before exiting the vaporization chamber through the third conduit.

7. The apparatus according to claim 4, further comprising a power supply connected to the separation chamber for applying an electrical bias thereto for attracting charged particles in the vaporized chemical.

8. The apparatus according to claim 4, wherein the vaporization chamber further comprises a gas jet plate disposed upstream of the separation chamber, the gas jet plate having a plurality of apertures through which the vaporized chemical passes for accelerating the flow rate of the vaporized chemical.

9. The apparatus according to claim 1, further comprising:
a fourth conduit connected to the vaporization chamber for introducing a dispersion gas to the vaporization chamber;
a reservoir space connected to receive the liquid chemical from the first conduit; and
a gas dispersion jet connected to receive the dispersion gas from the third conduit for jetting the dispersion gas into the liquid chemical in the reservoir space.

10. The apparatus according to claim 9, wherein the reservoir space is an annular space surrounding the gas dispersion jet, and the gas dispersion jet comprises a plurality of channels through which the dispersion gas is jetted.

11. A method for vaporizing a liquid chemical with the apparatus according to claim 1, comprising:
introducing a liquid chemical to be vaporized through the first conduit to the vaporization chamber;
introducing a carrier gas through the second conduit to the annular space, wherein the carrier gas flows from the annular space through the openings in the first annular wall to the vaporization space;
vaporizing the liquid chemical; and
removing the vaporized liquid chemical from the vaporization chamber through the third conduit.

12. An apparatus for vaporizing a liquid chemical to form a vapor phase product, comprising:
a vaporization chamber;
a first conduit connected to the vaporization chamber for introducing thereto a liquid chemical to be vaporized;
a second conduit connected to the vaporization chamber for introducing thereto a carrier gas;
a separation chamber at an upper end of the vaporization chamber for removing particles from the vaporized chemical; and
a third conduit connected to the separation chamber for supplying the vapor phase product to a point of use.

13. The apparatus according to claim 12, wherein the separation chamber comprises a cap over the upper end of the vaporization chamber, and wherein the third conduit is connected to the cap.

14. The apparatus according to claim 13, wherein the cap is spaced apart from the upper end of the vaporization chamber, forming a gap therebetween, and the cap forms an annular space with an outer portion of the vaporization chamber, whereby the vaporized chemical passes through the channel into the annular space before exiting the vaporization chamber through the third conduit.

15. The apparatus according to claim 12, further comprising a power supply connected to the separation chamber for applying an electrical bias thereto for attracting charged particles in the vaporized chemical.

16. The apparatus according to claim 12, wherein the vaporization chamber further comprises a gas jet plate disposed upstream of the separation chamber, the gas jet plate having a plurality of apertures through which the vaporized chemical passes for accelerating the flow rate of the vaporized chemical.

17. A method for vaporizing a liquid chemical with the apparatus according to claim 12, comprising:
introducing the liquid chemical to be vaporized through the first conduit to the vaporization chamber;
introducing a carrier gas through the second conduit to the vaporization chamber;
vaporizing the liquid chemical;
removing particles from the vaporized chemical in the separation chamber; and
removing the vapor phase product from the vaporization chamber through the third conduit.

18. An apparatus for vaporizing a liquid chemical to form a vapor phase product, comprising:
a vaporization chamber;
a first conduit connected to the vaporization chamber for introducing thereto a liquid chemical to be vaporized;
a second conduit connected to the vaporization chamber for introducing thereto a carrier gas;
a third conduit connected to the vaporization chamber for introducing thereto a dispersion gas to be contacted with the liquid chemical;
a reservoir space connected to receive the liquid chemical from the first conduit;
a gas dispersion jet connected to receive the dispersion gas from the third conduit for jetting the dispersion gas into the liquid chemical in the reservoir space; and
a fourth conduit connected to the vaporization chamber for supplying the vapor phase product to a point of use.

19. The apparatus of claim 18, wherein the second conduit and the third conduit are connected to receive the carrier gas and the dispersion gas, respectively, from the same gas source.

20. The apparatus according to claim 18, wherein the reservoir space is an annular space surrounding the gas dispersion jet, and the gas dispersion jet comprises a plurality of channels through which the dispersion gas is jetted.

21. The apparatus according to claim 20, wherein the gas dispersion jet comprises a central channel along its central axis and a plurality of openings extending from the central channel in the radial direction to allow for flow of the dispersion gas from the central channel to the reservoir space.

22. The apparatus according to claim 21, wherein the central channel of the gas dispersion jet extends to a top surface thereof and has a reduced diameter at the top surface.

23. The apparatus according to claim 18, further comprising a heater for providing heat of vaporization to the liquid chemical.

24. The apparatus according to claim 23, wherein the heater comprises plural electrical heating elements or an electric heating coil surrounding the vaporization chamber.

26. The apparatus according to claim 23, wherein the heater is a microwave heater.

27. The apparatus according to claim 18, further comprising a heater for heating the dispersion gas and/or the carrier gas upstream of the vaporization chamber.

28. A method for vaporizing a liquid chemical with the apparatus according to claim 18, comprising:
introducing the liquid chemical to be vaporized through the first conduit to the reservoir space;
introducing a carrier gas through the second conduit to the vaporization chamber;
introducing a dispersion gas through the third conduit to the gas dispersion jet, wherein the dispersion gas is jetted by the gas dispersion jet into the liquid chemical in the reservoir space, thereby forming droplets of the liquid chemical above the reservoir space;
vaporizing the liquid chemical; and
removing the vapor phase product from the vaporization chamber through the fourth conduit.

29. An apparatus for vaporizing a liquid chemical to form a vapor phase product, comprising:
a vaporization chamber;
a first conduit connected to the vaporization chamber for introducing thereto a liquid chemical to be vaporized from a liquid chemical source;
a second conduit connected to the vaporization chamber for introducing thereto a carrier gas for supplying heat of vaporization to the liquid chemical;
a third conduit connected to the vaporization chamber for supplying the vapor phase product to a point of use; and
a fourth conduit in fluid communication with one or more of the first conduit, the second conduit, the third conduit and the vaporization chamber for introducing thereto a cleaning solvent.

30. The apparatus according to claim 29, further comprising a vacuum source in fluid communication with one or more of the first conduit, the second conduit, the third conduit, the solvent supply conduit, and the vaporization chamber.

31. The apparatus according to claim 30, wherein the vacuum source is a venturi vacuum generator.

32. A method for vaporizing a liquid chemical with the apparatus according to claim 24, comprising:
introducing the liquid chemical to be vaporized through the first conduit to the vaporization chamber;
introducing a carrier gas through the second conduit to the vaporization chamber;
vaporizing the liquid chemical;
removing the vapor phase product from the vaporization chamber through the third conduit; and
introducing the cleaning solvent through the fourth conduit to one or more of the first conduit, the second conduit, the third conduit and the vaporization chamber.

33. The method according to claim 32, further comprising evacuating one or more of the first conduit, the second conduit, the third conduit and the vaporization chamber with a vacuum source prior to introducing the cleaning solvent.
